(19) United States
(12) Patent Application Publication
(10) Pub. No.: US 2024/0420866 A1
(43) Pub. Date: Dec. 19, 2024

(54) WIRING HARNESS AND HEAD-MOUNTED DEVICE WITH SAME

(71) Applicant: Beijing Zitiao Network Technology Co., Ltd., Beijing (CN)

(72) Inventors: Yu XIA, Beijing (CN); Jiu XIA, Beijing (CN); Guanghui LIU, Beijing (CN)

(21) Appl. No.: 18/706,378

(22) PCT Filed: Dec. 1, 2022
(86) PCT No.: PCT/CN2022/135927

§ 371 Date: Apr. 30, 2024

(30) Foreign Application Priority Data
Dec. 27, 2021 (CN) 202111615856.6

(51) Int. Cl. H01B 7/08; H01B 7/00; H01B 7/18; H01B 11/00

(52) U.S. Cl. CPC H01B 7/0823; H01B 7/0045; H01B 7/1895; H01B 11/00

(57) ABSTRACT

Disclosed are a wiring harness and a head-mounted device with the same. The wiring harness includes: a signal line including a plurality of signal conductors, a grounding wire including a plurality of grounding conductors, and a power cable including a plurality of power conductors, the signal line, the grounding wire and the power cable being disposed in the same outer sheath, and being sequentially arranged in a first direction.

### CROSS-REFERENCE TO RELATED APPLICATION

The present disclosure is filed on the basis of a Chinese patent application with application No. 2021116158566 and a filing date of Dec. 27, 2021, and claims the priority of the Chinese patent application, and the entire contents of the Chinese patent application are hereby incorporated into the present disclosure for reference.

### FIELD

The present disclosure relates to the technical field of head-mounted devices, and in particular, to a wiring harness and a head-mounted device with the same.

### BACKGROUND

Most all-in-one VR machines in the related art use rear-mounted batteries; and it is inevitable that a battery line between a rear-mounted battery and a head-mounted host that is mounted in the front of a corresponding machine is long. Because an all-in-one VR machine has higher power consumption and a large battery capacity, a battery line needs to be as thick as possible. This poses a significant challenge to the design of a structural space.

### SUMMARY

The present disclosure is intended to solve at least one of the technical problems existing in the prior art. In view of this, the present disclosure provides a wiring harness, so as to reduce a wiring space and decrease overall dimensions.

The present disclosure further provides a head-mounted device with the foregoing wiring harness.

A wiring harness according to an embodiment of the present disclosure, comprising: a signal line comprising a plurality of signal conductors; a grounding wire comprising a plurality of grounding conductors; and, a power cable comprising a plurality of power conductors, the signal line, the grounding wire and the power cable being disposed in a same outer sheath, and being sequentially arranged in a first direction.

According to the wiring harness in this embodiment of the present disclosure, the signal line, the grounding wire and the power cable share an outer sheath. In a case that a structural space is not changed, the wiring harness in this embodiment of the present disclosure may reserve a larger wiring space, so that more wires can be disposed for larger currents, and a current flow capability of the wiring harness is improved. Compared with a wiring harness in the related art, the wiring harness according to this embodiment of the present disclosure may have a reduced wiring space and decreased overall dimensions. This is conducive to overall miniaturization of an electronic device with the wiring harness.

In some embodiments of the present disclosure, the signal line further comprises a shielding layer wrapping outer sides of the plurality of signal conductors.

In some embodiments of the present disclosure, at least two of the signal conductor, the grounding conductor and the power conductor have different cross-sectional areas.

In some embodiments of the present disclosure, the cross-sectional area of the signal conductor is smaller than the cross-sectional area of the grounding conductor, the cross-sectional area of the signal conductor is smaller than the cross-sectional area of the power conductor.

In some embodiments of the present disclosure, a plurality of power cables is provided, and is disposed side by side.

In some embodiments of the present disclosure, a plurality of signal lines is provided, and the signal lines in a same network are disposed side by side.

In some embodiments of the present disclosure, a plurality of conductor groups is disposed in the outer sheath in a spaced manner, and each conductor group comprises a plurality of power cables disposed side by side, a plurality of grounding wires disposed side by side, and a plurality of signal lines disposed side by side.

In some embodiments of the present disclosure, the signal line further comprises a first filling member, the plurality of signal conductors is arranged into a circular ring surrounding the first filling member, and/or

the power cable comprises a second filling member, the plurality of power conductors is arranged into a circular ring surrounding the second filling member, and/or

the grounding wire comprises a third filling member, the plurality of grounding conductors is arranged into a circular ring surrounding the third filling member.

A head-mounted device according to an embodiment of the present disclosure, comprising: a host provided with an electrical control apparatus therein, and a battery portion connected to the electrical control apparatus through a wiring harness, the wiring harness being the wiring harness according to the wiring harness in any one of the above-mentioned embodiments of the present disclosure.

According to the head-mounted device provided in this embodiment of the present disclosure, the foregoing wiring harness is provided, so that a wiring space can be reduced, and overall dimensions of the wiring harness can be decreased. This is conducive to overall miniaturization of the head-mounted device.

Additional aspects and advantages of the present disclosure will be given in part in the description below, and some will become apparent from the description below or become known through the practice of this disclosure.

### BRIEF DESCRIPTION OF THE DRAWINGS

The above-mentioned and/or additional aspects and advantages of the present disclosure will become apparent and easy to understand from the description of embodiments in conjunction with the following drawings, wherein:

FIG. 1 is a schematic diagram of a wiring harness according to some embodiments of the present disclosure; and

FIG. 2 is a schematic diagram of a wiring harness according to some other embodiments of the present disclosure.

### REFERENCE NUMERALS

wiring harness 1000;
signal line 1; signal conductor 10; shielding layer 11; first filling member 12;
grounding wire 2; grounding conductor 20; third filling member 21;
power cable 3; power conductor 30; second filling member 31; and
outer sheath 4.

### DETAILED DESCRIPTION

The following describes in detail the embodiments disclosed herein, examples of which are shown in the drawings, where identical or similar labels throughout represent identical or similar components or components with identical or similar functions. The embodiments described below with reference to the accompanying drawings are illustrative and intended only to explain the present disclosure, and cannot be understood as limiting the present disclosure.

In the description disclosed herein, it should be understood that the terms “center”, “vertical”, “horizontal”, “length”, “width”, “thickness”, “top”, “bottom”, “front”, “back”, “left”, “right”, “vertical”, “horizontal”, “top”, “bottom”, “inside”, “outside”, “axial”, “radial”, “circumferential”, etc. indicate that the orientation or position relationship based on the orientation or position relationship shown in the drawings is only for the convenience of describing this disclosure and simplifying the description, and does not indicate or imply that the device or component referred to must have a specific orientation or be constructed in a specific orientation. And therefore, it cannot be understood as a limitation on this disclosure. In addition, features limited to “first” and “second” may explicitly or implicitly include one or more of these features. In the description disclosed herein, unless otherwise specified. “multiple” means two or more.

In the description disclosed herein, it should be noted that unless otherwise specified and limited, the terms “installation”. “connection”, and “connection” should be broadly understood, for example, they can be fixed connections, detachable connections, or integrated connections; It can be a mechanical connection or an electrical connection; It can be directly connected, or indirectly connected through an intermediate medium, or it can be an internal connection between two components. For ordinary technical personnel in this field, they can understand the specific meanings of the above terms in this disclosure based on specific circumstances.

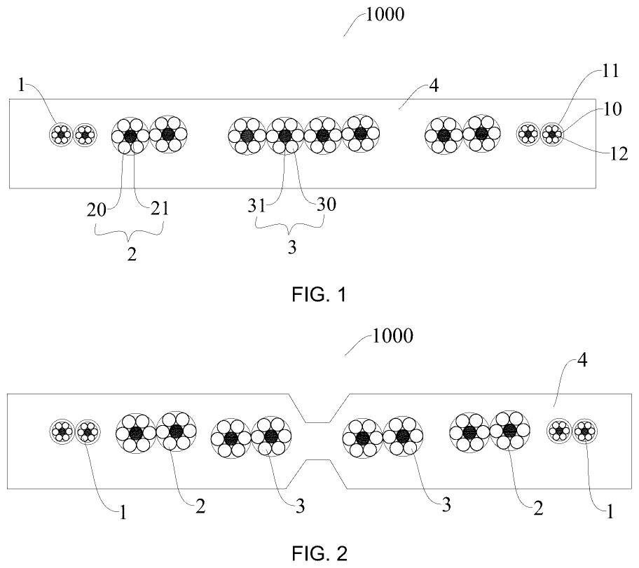

A wiring harness 1000 according to embodiments of the present disclosure is described below with reference to FIG. 1 and FIG. 2. The wiring harness 1000 may be applicable to an electronic device and is configured to connect a battery portion to a host. The electronic device may be a head-mounted device, for example, an all-in-one VR machine.

The wiring harness 1000 according to the embodiments of the present disclosure includes signal lines 1, grounding wires 2 and power cables 3. Each signal line 1 includes a plurality of signal conductors 10. Each grounding wire 2 includes a plurality of grounding conductors 20. Each power cable 3 includes a plurality of power conductors 30. The signal lines 1, the grounding wires 2 and the power cables 3 are disposed in the same outer sheath 4, and are sequentially arranged in a first direction. In some examples of the present disclosure, the signal lines 1, the grounding wires 2 and the power cables 3 are sequentially arranged in the width direction of the wiring harness 1000. In the length direction of the wiring harness 1000, two ends of the wiring harness 1000 are connected to the battery portion and the host, respectively.

It should be noted that a power cable of a wiring harness in the related art is provided with a power conductor and a power outer sheath wrapping the power conductor; a signal line of the wiring harness in the related art is provided with a signal conductor and a signal outer sheath wrapping the signal conductor; a grounding wire of the wiring harness in the related art is provided with a grounding conductor and a grounding outer sheath wrapping the grounding outer sheath; and the wiring harness in the related art has larger dimensions. As a result, dimensions of an electronic device provided with the wiring harness are larger.

In the wiring harness 1000 according to the embodiments of the present disclosure, the signal lines 1, the grounding wires 2 and the power cables 3 share an outer sheath 4. In a case that a structural space is not changed, the wiring harness 1000 in this embodiment of the present disclosure may reserve a larger wiring space, so that more wires can be disposed for larger current, so that a current flow capability of the wiring harness 1000 is improved. Compared with a wiring harness in the related art, the wiring harness 1000 according to the embodiments of the present disclosure may have a reduced wiring space and decreased overall dimensions. This is conducive to overall miniaturization of an electronic device with the wiring harness.

It should be noted that the shape, the width, the thickness, and the like of the outer sheath 4 in the embodiments of the present disclosure may be set according to an actual space requirement. This is not specifically limited herein.

In some embodiments of the present disclosure, as shown in FIG. 1 and FIG. 2, each signal line 1 further includes a shielding layer 11 wrapping outer sides of the plurality of signal conductors 10. It may be understood that in this case, the entire outer sheath 4 wraps the shielding layer 11. Therefore, due to arrangement of the shielding layer 11, an external signal can be further prevented from interfering with the signal conductor 10 to ensure that the signal conductor 10 can transmit a signal without any interference as far as possible. In some other examples of the present disclosure, the entire outer sheath 4 may be provided as a shielding member, so that interference to signals of the grounding wires 2, the signal lines 1 and the power cables 3 can be reduced.

It should be noted that because currents transmitted in the power cable 3, the grounding wire 2, and the signal line 1 may be different, cross-sectional areas of the power conductor 30, the grounding conductor 20, and the signal conductor 10 may be defined based on actually transmitted currents. Therefore, in some embodiments of the present disclosure, at least two of the signal conductor 10, the grounding conductor 20 and the power conductor 30 have different cross-sectional areas. In other words, all of the cross-sectional areas of the signal conductor 10, the grounding conductor 20 and the power conductor 30 may be different from each other; or the cross-sectional areas of the grounding conductor 20 and the power conductor 30 are the same; or the cross-sectional area of the signal conductor 10 is different from the cross-sectional areas of both the grounding conductor 20 and the power conductor 30. This may be defined according to actual conditions. Therefore, the size of the wiring harness 1000 can be further reduced.

It should be noted that compared with the signal line 1, the power cable 3 and the grounding wire 2 are required to transmit larger currents, so that as shown in FIG. 1 and FIG. 2, in some embodiments of the present disclosure, the cross-sectional area of the signal conductor 10 is the smallest. Therefore, the size of the wiring harness 1000 can be further reduced.

In some specific examples of the present disclosure, the cross-sectional area of the signal conductor 10 is smaller than the cross-sectional area of the grounding conductor 20; and/or the cross-sectional area of the signal conductor 10 is smaller than the cross-sectional area of the power conductor 30. Therefore, the size of the wiring harness 1000 can be further reduced. It should be noted that types of the power conductor 30, the signal conductor 10 and the grounding conductor 20 may be defined according to actual conditions. This is not specifically limited herein.

As shown in FIG. 1 and FIG. 2, in some examples of the present disclosure, the cross-sectional areas of the grounding conductor 20 and the power conductor 30 are the same. In other words, conductors of uniform models may be selected, so that types of parts can be reduced, thereby reducing costs.

In some embodiments of the present disclosure, as shown in FIG. 1, a plurality of power cables 3 is provided, and is disposed side by side. In other words, the plurality of power cables 3 is disposed next to each other side by side, that is, neither grounding wire 2 nor signal line 1 is disposed between adjacent power cables 3, so that conductor impedance can be lower, current flowing the wiring harness 1000 can be increased, and the size of the wiring harness 1000 can be reduced.

As shown in FIG. 1 and FIG. 2, in some examples of the present disclosure, a plurality of grounding wires 2 is provided, and is disposed side by side. In other words, the plurality of grounding wires 2 is disposed next to each other side by side, that is, neither power cable 3 and nor signal line 1 is disposed between adjacent grounding wires 2, so that conductor impedance can be reduced, and the size of the wiring harness 1000 can be reduced. Further, as shown in FIG. 1 and FIG. 2, a plurality of signal lines 1 is provided. The signal lines 1 in the same network are disposed side by side, that is, neither grounding wire 2 and nor power cable 3 is disposed between adjacent signal lines 1 in the same network. It should be noted that in description of the present disclosure, signal lines 1 in the same network transmit the same information signal. For example, relative to the host, the information signal includes an input information signal and an output information signal. In this case, signal lines 1 transmitting the same input information signal may be disposed side by side; and signal lines 1 transmitting the same output information signal may be disposed side by side.

As shown in FIG. 1, in some specific examples of the present disclosure, the wiring harness 1000 includes four power cables 3, four grounding wires 2 and four signal lines 1. The four power cables 3 are disposed next to each other side by side. Each of the left and right sides of the four power cables 3 is provided with two grounding wires 2 disposed next to each other side by side and two signal lines 1 disposed next to each other side by side.

In some examples of the present disclosure, as shown in FIG. 2, a plurality of conductor groups is disposed in the outer sheath 4 in a spaced manner. Each conductor group includes a plurality of power cables 3 disposed side by side, a plurality of grounding wires 2 disposed side by side, and a plurality of signal lines 1 disposed side by side, so that the wiring harness 1000 can transmit a plurality of signals.

As shown in FIG. 2, in some other specific examples of the present disclosure, the wiring harness 1000 includes four power cables 3, four grounding wires 2 and four signal lines 1. The four power cables 3, the four grounding wires 2 and the four signal lines 1 are divided into two groups in the width direction of the outer sheath 4, wherein each group includes two power cables 3 disposed next to each other side by side, two grounding wires 2 disposed next to each other side by side, and two signal lines 1 disposed next to each other side by side.

It should be noted that quantities of the power cables 3, the grounding wires 2 and the signal lines 1 are not limited thereto; and arrangement positions of the power cables 3, the grounding wires 2 and the signal lines 1 are not limited thereto, either. These may be defined according to actual conditions, provided that the power cables 3, the grounding wires 2 and the signal lines 1 are disposed in the same outer sheath 4.

As shown in FIG. 1 and FIG. 2, in some embodiments of the present disclosure, the signal line 1 further includes a first filling member 12; and the plurality of signal conductors 10 is arranged into a circular ring surrounding the first filling member 12, so that the size of the signal line 1 can be reduced, and the size of the wiring harness 1000 can be further reduced; and due to supporting of the first filling member 12, the reliable arrangement of the plurality of signal conductors 10 can be ensured.

As shown in FIG. 1 and FIG. 2, in some embodiments of the present disclosure, the power cable 3 includes a second filling member 31. The plurality of power conductors 30 is arranged into a circular ring surrounding the second filling member 31; and/or the grounding wire 2 includes a third filling member 21, wherein the plurality of grounding conductors 20 is arranged into a circular ring surrounding the third filling member 21. Therefore, the size/sizes of the power cable 3 and/or the grounding wire 2 can be reduced, and the size of the wiring harness 1000 can be further reduced; due to supporting of the second filling member 31, the reliable arrangement of the plurality of power conductors 30 can be ensured; and due to supporting of the third filling member 21, the reliable arrangement of the plurality of grounding conductors 20 can be ensured.

In some specific examples of the present disclosure, as shown in FIG. 1 and FIG. 2, there are four signal lines 1, four power cables 3 and four grounding wires 2. The four signal lines 1, the four power cables 3 and the four grounding wires 2 are disposed in the same outer sheath 4. Each signal line 1 includes a plurality of signal conductors 10, a first filling member 12, and a shielding layer 11. The plurality of signal conductors 10 is sequentially arranged in the circumferential direction of the first filling member 12. The shielding layer 11 wraps outer sides of the plurality of signal conductors 10.

Each power cable 3 includes a plurality of power conductors 30 and a second filling member 31. The plurality of power conductors 30 is arranged into a circular ring surrounding the second filling member 31. Each grounding wire 2 includes a plurality of grounding conductors 20 and a third filling member 21. The plurality of grounding conductors 20 is arranged into a circular ring surrounding the third filling member 21.

In some embodiments of the present disclosure, the wiring harness 1000 further includes wiring terminals. Two ends of the outer sheath 4 are provided with the wiring terminals, respectively. Each wiring terminal is electrically connected to the signal lines 1, the grounding wires 2 and the power cables 3. In other words, the wiring harness 1000 may be connected to the battery portion and the host through the wiring terminals. Therefore, a connection manner of the wiring harness 1000 is simplified. Certainly, it may be understood that part of the signal line 1, part of the grounding wire 2 and part of the power cable 3 may be enabled to extend out of the outer sheath 4, and thus can be electrically connected to the battery portion and the host in an electrical connection manner, such as welding or screwing.

The head-mounted device according to the embodiments of the present disclosure includes a host and a battery portion. An electrical control apparatus is arranged in the host. The battery portion is connected to the electrical control apparatus through a wiring harness 1000 that is the wiring harness 1000 according to any one of the foregoing embodiments of the present disclosure. Optionally, the head-mounted device may be an all-in-one VR machine.

According to the head-mounted device in the embodiments of the present disclosure, the foregoing wiring harness 1000 is provided, so that a wiring space can be reduced, and overall dimensions of the wiring harness 1000 can be reduced. This is conducive to overall miniaturization of the head-mounted device.

In some examples of the present disclosure, the battery portion is disposed behind the host; and the top of the battery portion may be connected to the host through the wiring harness 1000, or a lateral portion of the battery portion may be connected to the host through the wiring harness 1000.

In the description of this specification, the reference terms “one embodiment”. “some embodiments”. “illustrative embodiments”. “examples”. “specific examples”, or “some examples” refer to specific features, structures, materials, or features described in conjunction with the embodiments or examples included in at least one embodiment or example disclosed herein. In this manual, the illustrative expressions of the above terms may not necessarily refer to the same embodiments or examples. Moreover, the specific features, structures, materials, or features described can be appropriately combined in any one or more embodiments or examples.

Although embodiments of the present disclosure have been shown and described, those skilled in the art may understand that various changes, modifications, substitutions, and variations can be made to these embodiments without departing from the principles and purposes of the present disclosure. The scope of the present disclosure is limited by the claims and their equivalents.

1. A wiring harness, comprising:
a signal line comprising a plurality of signal conductors;
a grounding wire comprising a plurality of grounding conductors; and
a power cable comprising a plurality of power conductors, the signal line, the grounding wire and the power cable being disposed in a same outer sheath, and being sequentially arranged in a first direction.

2. The wiring harness according to claim 1, wherein the signal line further comprises a shielding layer wrapping outer sides of the plurality of signal conductors.

3. The wiring harness according to claim 1, wherein at least two of the signal conductor, the grounding conductor and the power conductor have different cross-sectional areas.

4. The wiring harness according to claim 3, wherein the cross-sectional area of the signal conductor is smaller than the cross-sectional area of the grounding conductor, and/or the cross-sectional area of the signal conductor is smaller than the cross-sectional area of the power conductor.

5. The wiring harness according to claim 1, wherein a plurality of power cables is provided, and is disposed side by side.

6. The wiring harness according to claim 1, wherein a plurality of grounding wires is provided, and is disposed side by side.

7. The wiring harness according to claim 1, wherein a plurality of signal lines is provided, and the signal lines in a same network are disposed side by side.

8. The wiring harness according to claim 1, wherein a plurality of conductor groups is disposed in the outer sheath in a spaced manner, and each conductor group comprises a plurality of power cables disposed side by side, a plurality of grounding wires disposed side by side, and a plurality of signal lines disposed side by side.

9. The wiring harness according to any one of claims 1 to 8, wherein the signal line further comprises a first filling member, the plurality of signal conductors is
arranged into a circular ring surrounding the first filling member, and/or the power cable comprises a second filling member, the plurality of power conductors is arranged into a circular ring surrounding the second filling member, and/or
the grounding wire comprises a third filling member, the plurality of grounding conductors is arranged into a circular ring surrounding the third filling member.

10. A head-mounted device, comprising:
a host provided with an electrical control apparatus therein, and
a battery portion connected to the electrical control apparatus through a wiring harness, the wiring harness comprising:
a signal line comprising a plurality of signal conductors;
a grounding wire comprising a plurality of grounding conductors; and
a power cable comprising a plurality of power conductors, the signal line, the grounding wire and the power cable being disposed in a same outer sheath, and being sequentially arranged in a first direction.

11. The head-mounted device of claim 10, wherein the signal line further comprises a shielding layer wrapping outer sides of the plurality of signal conductors.

12. The head-mounted device of claim 10, wherein at least two of the signal conductor, the grounding conductor and the power conductor have different cross-sectional areas.

13. The head-mounted device of claim 12, wherein the cross-sectional area of the signal conductor is smaller than the cross-sectional area of the grounding conductor, and/or the cross-sectional area of the signal conductor is smaller than the cross-sectional area of the power conductor.

14. The head-mounted device of claim 10, wherein a plurality of power cables is provided, and is disposed side by side.

15. The head-mounted device of claim 10, wherein a plurality of grounding wires is provided, and is disposed side by side.

16. The head-mounted device of claim 10, wherein a plurality of signal lines is provided, and the signal lines in a same network are disposed side by side.

17. The head-mounted device of claim 10, wherein a plurality of conductor groups is disposed in the outer sheath in a spaced manner, and each conductor group comprises a plurality of power cables disposed side by side, a plurality of grounding wires disposed side by side, and a plurality of signal lines disposed side by side.

18. The head-mounted device of claim 10, wherein the signal line further comprises a first filling member, the plurality of signal conductors is arranged into a circular ring surrounding the first filling member.

19. The head-mounted device of claim 10, wherein the power cable comprises a second filling member, the plurality of power conductors is arranged into a circular ring surrounding the second filling member.

20. The head-mounted device of claim 10, wherein the grounding wire comprises a third filling member, the plurality of grounding conductors is arranged into a circular ring surrounding the third filling member.
